(19) United States
(12) Patent Application Publication
(10) Pub. No.: US 2026/0155298 A1
(43) Pub. Date: Jun. 4, 2026

(54) BOBBIN AND TRANSFORMER

(71) Applicant: Delta Electronics (Shanghai) Co., Ltd., Shanghai (CN)

(72) Inventors: Linyan XIAO, Shanghai (CN); Yanwei HU, Shanghai (CN); HSIEH SHEN HSIEH, Shanghai (CN); Xueyong ZHAI, Shanghai (CN)

(21) Appl. No.: 18/966,012

(22) Filed: Dec. 2, 2024

(51) Int. Cl. H01F 27/32; H01F 27/24; H01F 27/28

(52) U.S. Cl. CPC H01F 27/325; H01F 27/24; H01F 27/2823

(57) ABSTRACT

An embodiment of the present application specifically relates to a bobbin and a transformer, and belongs to the technical field of transformers. The bobbin includes a winding reel and at least one pin connection part, the at least one pin connection part is provided on an end face of the winding reel. The pin connection part includes a plurality of connecting through-holes and a first wire-passing groove, each of the connecting through-holes is inserted with a pin. The first wire-passing groove is located between two adjacent connecting through-holes, the first wire-passing groove passes through the pin connection part along a direction of a center line of the winding reel. The partial area of the groove wall of the first wire-passing groove is located in at least one connecting through-hole adjacent the first wire-passing groove to expose the pin.

### TECHNICAL FIELD

The embodiments of the present application relate to the technical field of magnetic components, and particularly relate to a bobbin and a transformer.

### BACKGROUND

With the development of electronic technology, low-power transformers are widely used in new energy vehicles and other fields. A transformer usually includes a bobbin and a winding wound around the bobbin.

In the related art, the bobbin generally includes a winding reel and a pin connection part. The winding reel is used to wind the winding. The pin connection part is connected to an edge of one end of the winding reel. The pin connection part is provided with a plurality of connecting through-holes at intervals, each connecting through-hole is inserted with a pin, and a wire-passing groove is provided between two adjacent connecting through-holes, so that a lead wire of the winding after being threaded can be connected with the pin in the connecting through-hole.

However, the inventor realized that the bobbin in the related technology has a large volume, which is not beneficial to the miniaturization of the transformer.

### SUMMARY

In view of this, an embodiment of the present application provides a bobbin and a transformer to solve a technical problem that the volume of the bobbin is large, which is not beneficial to the miniaturization of the transformer.

A first aspect of the embodiment of the present application provides a bobbin, the bobbin includes a winding reel and at least one pin connection part. The winding reel is used to wind a winding; the at least one pin connection part is provided on an end surface of the winding reel, the pin connection part is provided with a plurality of connecting through-holes and at least one first wire-passing groove, the plurality of connecting through-holes are arranged at intervals along a direction parallel to the end surface of the winding reel, and each connecting through-hole is inserted with a pin;

where, the first wire-passing groove is located between two adjacent connecting through-holes, the first wire-passing groove passes through the pin connection part along a direction of a center line of the winding reel, the first wire-passing groove includes groove wall, and a partial area of the groove wall is located in at least one connecting through-hole adjacent to the first wire-passing groove, therefore, the pin is exposed from the connecting through-hole.

The bobbin of the embodiment of the present application includes a winding wound around the winding reel. The lead wire of the winding passes through the first wire-passing groove to be connected with the pin inserted into the connecting through-hole. Since a partial area of the groove wall of the first wire-passing groove is located in at least one connecting through-hole adjacent the first wire-passing groove to expose the pin, it is equivalent to removing a part of the pin connection part between the wire-passing groove and the connecting through-hole in the related art, thereby increasing a width of the first wire-passing groove along a direction perpendicular to the center line of the winding reel. Compared to spacing arrangement between the wire-passing groove and the connecting through-holes in the related art, under the condition of meeting same width requirements of the wire-passing groove, the bobbin of the embodiment of the present application can reduce the distance between adjacent pins, thereby reducing the volume of the bobbin which is beneficial to the miniaturization of the transformer.

A second aspect of an embodiment of the present application provides a transformer, the transformer includes a magnetic core assembly, a winding, a protection member, and a bobbin as described in any one of the above items; the magnetic core assembly includes two opposing magnetic cores; at least part of the winding reel of the bobbin is provided within the magnetic core assembly; the winding is provided on the winding reel, the winding is electrically connected to a pin of the pin connection part in the bobbin; the protection member includes a suction member part and an isolating part, the suction member part is at least partially provided above the bobbin; the isolating part is connected to the suction member part, the isolating part covers at least part of the winding reel and at least part of the pin connection part, and the isolating part is used to isolate the pin of the pin connection part.

Since the transformer of the embodiment of the present application includes the bobbin as described in any one of the above items, the transformer also has the advantages of the bobbin as described in any one of the above items, which will not be repeated here.

### BRIEF DESCRIPTION OF DRAWINGS

In order to more clearly illustrate the technical solutions in the embodiments of the present application or the prior art, the following will briefly introduce the drawings required for use in the embodiments or the prior art description. Obviously, the drawings described below are some embodiments of the present application. For ordinary technicians in this field, other drawings can also be obtained based on these drawings without creative work.

FIG. 1 is a first perspective schematic structural diagram of a bobbin of an embodiment of the present application.

FIG. 2 is a schematic structural diagram of the bobbin in FIG. 1 when connecting lead wires.

FIG. 3 is a second perspective schematic structural diagram of the bobbin in FIG. 1.

FIG. 4 is a top view schematic structural diagram of the bobbin in FIG. 3.

FIG. 5 is a front view schematic structural diagram of the bobbin in FIG. 3.

FIG. 6 is a local schematic structural diagram of a pin connection part in some embodiments of the present application.

FIG. 7 is a local schematic structural diagram of a pin connection part in some other embodiments of the present application.

FIG. 8 is a schematic structural diagram of a bobbin in some other embodiments of the present application.

FIG. 9 is a schematic structural diagram of a transformer in an embodiment of the present application.

FIG. 10 is an exploded schematic structural diagram of a transformer in FIG. 9.

FIG. 11 is a cross-sectional diagram of a transformer in other embodiments of the present application.

FIG. 12 is an exploded schematic structural diagram of the magnetic core assembly in FIG. 9.

FIG. 13 is a schematic structural diagram of the magnetic core assembly in FIG. 9.

FIG. 14 is a third perspective schematic structural diagram of a protection member in FIG. 9.

FIG. 15 is a fourth perspective schematic structural diagram of a protection member in other embodiments of the present application.

FIG. 16 is a fifth perspective schematic structural diagram of a protection member in FIG. 15.

FIG. 17 is a schematic structural diagram of a bobbin in FIG. 9.

FIG. 18 is a perspective diagram of a bobbin in FIG. 17.

### DESCRIPTION OF EMBODIMENTS

As described in the background, the bobbin in the related art has a technical problem of large volume. According to the research of the inventors, the reason is that the bobbin in the related art usually includes a winding reel and a pin connection part. The winding reel is used to wind the winding. The pin connection part is connected to an edge of an end of the winding reel. The pin connection part is provided with a plurality of connecting through-holes, and the plurality of connecting through-holes are arranged at intervals along a direction parallel to an end surface of the winding reel. Each connecting through-hole is inserted with a pin. A wire-passing groove is provided between two adjacent connecting through-holes. The wire-passing groove is connected to the pin after being threaded by a lead wire of the winding. However, in the bobbin of the related art, the wire-passing groove and two connecting through-holes adjacent the wire-passing groove are all arranged at intervals, which make a distance between the two pins wider and makes a volume of the bobbin larger, which is not beneficial to the miniaturization of the transformer.

In the related art, the inventor tried to reduce the distance between two adjacent pins to reduce the volume of the bobbin, so as to meet the requirements of miniaturization of the transformer, but the technical difficulty is large. Specifically, spacing between two adjacent pins in the bobbin is a sum of a groove width of the wire-passing groove and a width between hole-walls of the two connecting through-holes and groove walls of the wire-passing groove. First, since the wire groove is provided for threading the lead wires of the winding, the width of the wire groove is limited by a wire diameter of the lead wire and cannot be reduced. Second, the hole-wall of the connecting through-hole needs to attached to the circumferential side surface of the pin so that the pin connection part can wrap the pin. That is, the width between the hole-wall of the connecting through-hole and the groove wall of the wire-passing groove needs to be greater than zero, so that there is sufficient connection strength between the pin and the pin connection part to avoid the lead wire connected to the pin from exerting tension on the pin during the winding process which makes the pin from shaking. Therefore, miniaturization of the transformer has become a technical problem that technicians in this field have always wanted to solve but have never succeeded.

In view of this, for the bobbin of the embodiment of the present application, by setting the first wire-passing groove between adjacent connecting through-holes, and a partial area of the groove wall of the first wire-passing groove is located in at least one connecting through-hole adjacent the first wire-passing groove to expose the pin, so that the spacing between two adjacent pins is reduced under the condition of ensuring that the first wire-passing groove meets the width requirements, thereby further reducing the volume of the bobbin which is beneficial to the miniaturization of the transformer.

In order to make the purpose, technical solution and advantages of the embodiments of the present application clearer, the technical solution in the embodiment of the present application will be clearly and completely described in combination with the accompanying drawings in the embodiment of the present application in the following. Obviously, the described embodiment is a part of the embodiments of the present application, not all of the embodiments. Based on the embodiments in the present application, all other embodiments obtained by ordinary technicians in this field without creative work are within the protection scope of the present application.

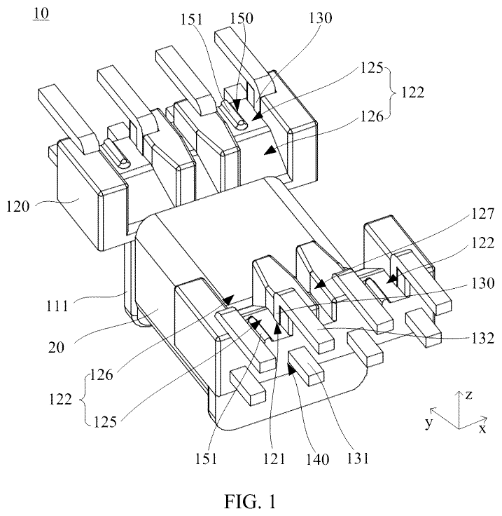

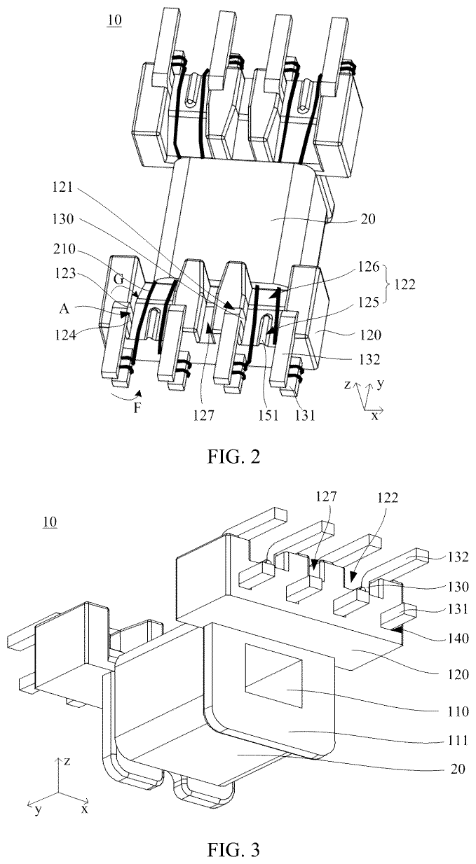

Referring to FIG. 1, FIG. 2 and FIG. 3, an embodiment of the present application provides a bobbin 10, including a winding reel 110 and at least one pin connection part 120. The winding reel 110 is used to wind the winding 20. At least one pin connection part 120 is provided on an end surface of the winding reel 110. The pin connection part 120 is arranged with a plurality of connecting through-holes 121 and at least one first wire-passing groove 122. The plurality of connecting through-holes 121 are arranged at intervals along a direction parallel to the end surface of the winding reel 110, for example, the direction x shown in FIG. 1, and each connecting through-hole 121 is inserted with a pin 130. Where, the first wire-passing groove 122 is located between two adjacent connecting through-holes 121, and the first wire-passing groove 122 passes through the pin connection part 120 along a direction of the center line of the winding reel 110. A partial area of the groove wall of the first wire-passing groove 122 is located in at least one connecting through-hole 121 adjacent the first wire-passing groove 122 to expose the pin 130.

The bobbin 10 of the embodiment of the present application includes a winding 20 wound around the winding reel 110. The lead wire 210 of the winding 20 passes through the first wire-passing groove 122 to be connected with the pin 130 inserted into the connecting through-hole 121. Since a partial area of the groove wall of the first wire-passing groove 122 is located in at least one connecting through-hole 121 adjacent the first wire-passing groove 122 to expose the pin 130, it is equivalent to removing a part of the pin connection part between the wire-passing groove and the connecting through-hole in the related art, and increasing the width of the first wire-passing groove 122 along a direction perpendicular to the center line of the winding reel 110, for example, along the direction x shown in FIG. 1. Compared to spacing arrangement between the wire-passing groove and the connecting through-holes in the related art, under the condition of meeting same requirements of the wire-passing groove, the bobbin of the embodiment of the present application can reduce the distance between adjacent pins, thereby reducing the volume of the bobbin which is beneficial to the miniaturization of the transformer. For example, in the related art, an original distance between the two pins can be 1.8 mm, the width between the hole-wall of the connecting through-hole and the groove wall of the wire-passing groove can be 2*0.6 mm, and the width between the hole-wall of the connecting through-hole and the groove wall of the wire-passing groove accounts for 66% of the spacing between the two pins. After removing the portion of the pin connection part located between the wire-passing groove and the connecting through-hole, the spacing between the two pins can be 0.6 mm, which is reduced by 66%.

In addition, without changing the distance between adjacent pins 130, the bobbin 10 of the embodiment of the present application can increase the width of the first wire-passing groove 122, thereby increasing the wire-passing space of the lead wire of the winding 20, reducing or eliminating a restriction of the bobbin 10 on the winding method of the winding 20, improving application scope of the bobbin 10, and facilitating generalization of the bobbin 10.

In addition, a partial area of the groove wall of the first wire-passing groove 122 is located in at least one connecting through-hole 121 adjacent the first wire-passing groove 122 to expose the pin 130, that is, the portion of the pin connection part 120 located between the first wire-passing groove 122 and the connecting through-hole 121 is removed, and sufficient connection strength between the pin connection part 120 and the pin 130 can still be ensured. Specifically, referring to FIG. 2, first, since a partial area A where the pin 130 is inserted into the connecting through-hole 121 is exposed by the first wire-passing groove 122, but not entire area is exposed by the first wire-passing groove 122. An area where the pin 130 is inserted into the connecting through-hole 121 and not exposed by the first wire-passing groove 122 is still wrapped by the pin connection part 120, which can ensure the sufficient connection strength between the pin connection part 120 and the pin 130.

Second, since the pin connection part 120 is connected to the end surface of the winding reel 110, and the first wire-passing groove 122 passes through the pin connection part 120 along the center line of the winding reel 110, for example, the direction y shown in FIG. 2, so that the lead wire 210 of the winding 20 is routed, for example, along the direction y, and the lead wire 210 applies a torque F to the pin 130. The first hole-wall 123 and the second hole-wall 124 adjacent to the removed hole-wall in the connecting through-hole 121 are the main force-bearing surfaces. The first hole-wall 123 and the second hole-wall 124 apply a torque G to the pin 130, and a direction of the torque G is opposite to a direction of the torque F to balance the torque F. However, the other hole-walls in the connecting through-hole 121 except for the first hole-wall 123 and the second hole-wall 124 are not the main force-bearing surfaces. After removing the non-main force-bearing surfaces, there is still sufficient connection strength between the pin connection part 120 and the pin 130. Therefore, after removing the portion of the pin connection part 120 between the first wire-passing groove 122 and the connecting through-hole 121, the pin connection part 120 and the pin 130 still have sufficient connection strength.

Exemplarily, the winding reel 110 may be a cylindrical structure or a square cylindrical structure. A magnetic core assembly may also be provided inside the winding reel 110 to enhance the magnetic field strength of the transformer. Exemplarily, a limiting part 111 may also be provided on the end surface of the winding reel 110, and the limiting part 111 is used to limit the winding 20 to prevent the winding 20 from detaching from the winding reel 110, thereby improving reliability of the transformer.

At least one pin connection part 120 is provided on the end surface of the winding reel 110. The pin connection part 120 and the winding reel 110 may be integrated to enhance the connection strength between the pin connection part 120 and the winding reel 110. For example, the pin connection part 120 and the winding reel 110 may be integrally formed by injection molding or the like.

Exemplarily, number of pin connection parts 120 may be one, and one pin connection part 120 may be connected to any end surface of the winding reel 110. Exemplarily, referring to FIG. 1, the number of pin connection parts 120 may also be two, and the two pin connection parts 120 may be respectively provided on opposite two end surfaces of the winding reel 110. Exemplarily, the number of pin connection parts 120 may also be multiple, and the multiple pin connection parts 120 may be respectively provided on the opposite two end surfaces of the winding reel 110. It is understandable that the number of pin connection parts 120 may also be specifically set according to the number of pins 130 and the lead wires 210 in the winding 20, and the embodiments of the present application will not be repeated here.

Referring to FIG. 1 to FIG. 3, the pin connection part 120 may be provided with multiple connecting through-holes 121, and the connecting through-holes 121 are used to insert the pins 130. The plurality of connecting through-holes 121 are arranged at intervals along the direction parallel to the end surface of the winding reel 110 (for example, along the direction x), so that the plurality of pins 130 inserted into the connecting through-holes 121 are arranged at intervals along the direction parallel to the end surface of the winding reel 110.

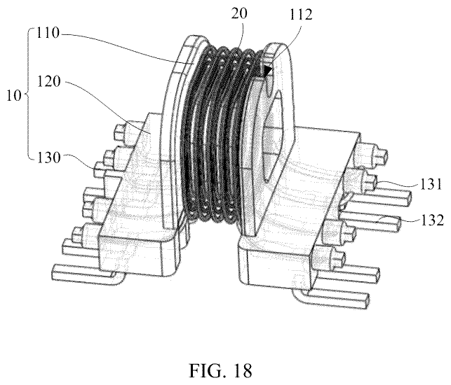

In some embodiments of the present application, as shown in FIG. 17 and FIG. 18, the bobbin may also include a connecting terminal 131. Where, the connecting terminal 131 is electrically connected to the pin 130, and exemplarily, some connecting terminals 131 can also be not electrically connected to the corresponding pin 130. The connecting terminal 131 can be electrically connected to the lead wire 210 of the winding 20. The pin 130 is electrically connected to the winding 20 through the connecting terminal 131, and the connecting terminal 131 serves as the lead-out end of the winding 20 to lead out the lead wire 210 of the winding 20. In some embodiments of the present application, the pin 130 can be electrically connected to the PCB, and the PCB is used to place other devices.

Exemplarily, the connecting terminal 131 and the pin 130 may adopt a separate design. If the connecting terminal 131 and the pin 130 do not adopt a separate design, when the whole transformer is in a high vibration environment, the pin 130 will vibrate with the vibration of the PCB connected the pin 130. At this time, the pin 130 will transmit the vibration to a wire welding side, resulting in a wire breakage situation. In the embodiment of the present application, the connecting terminal 131 and the pin 130 adopt a separate design, so the vibration on the pin 130 will not directly affect the connecting terminal 131, avoiding the wire breakage situation, and ensuring the high vibration resistance of the transformer.

It is understandable that, as shown in FIG. 17 and FIG. 18, a middle part of the pin 130 can be embedded in interior of the pin connection part 120, which is equivalent to the middle part being hidden in the interior of the pin connection part 120, thereby it can avoid the mutual influence between the connecting terminal 131 and the pin 130. In this way, the connecting terminal 131 and a part of the pin 130 located outside the pin connection part 120 are separated from each other, but they conduct with each other inside the pin connection part 120.

It can be understood that the pin 130 can be at least one of a L-shape, an inverted L-shape or a C-shape, a separated seagull foot structure, and a gull wing structure.

In some embodiments of the present application, the pin connection part 120 can have multiple sides, and the connecting terminal 131 and the pin 130 can be provided on different sides of the pin connection part 120, so that a lead wire welding point and a PCB welding point are in different areas, further ensuring a separation effect between the connecting terminal 131 and the pin 130.

Referring to FIG. 1 to FIG. 3, an end of the pin 130 close to the winding reel 110 can extend out of the connecting through-hole 121 and bend in a direction away from the winding reel 110 to form a first bending part, and the first bending part can form the connecting terminal 131, that is, the connecting terminal 131 and the pin 130 can be an integrated structure. The first bending part can be used to connect the lead wire 210 of the winding 20. For example, the lead wire 210 of the winding 20 can be sleeved on the first bending part, thereby improving convenience of connecting the pin 130 with the lead wire 210. An end of the pin 130 away from the winding reel 110 can extend out of the connecting through-hole 121 and bend in the direction away from the winding reel 110 to form a second bending part 132. The second bending part 132 can be used for welding with the circuit board. Since the circuit board is welded to the second bending part 132, the second bending part 132 bears stress. However, the lead wire 210 of the winding 20 is connected to the first bending part which is not directly welded to the circuit board, so the vibration on the second bending part 132 will not directly affect the first bending portion, avoiding the wire breakage situation, and improving the vibration resistance when the pin 130 is connected to the lead wire 210 of the winding 20.

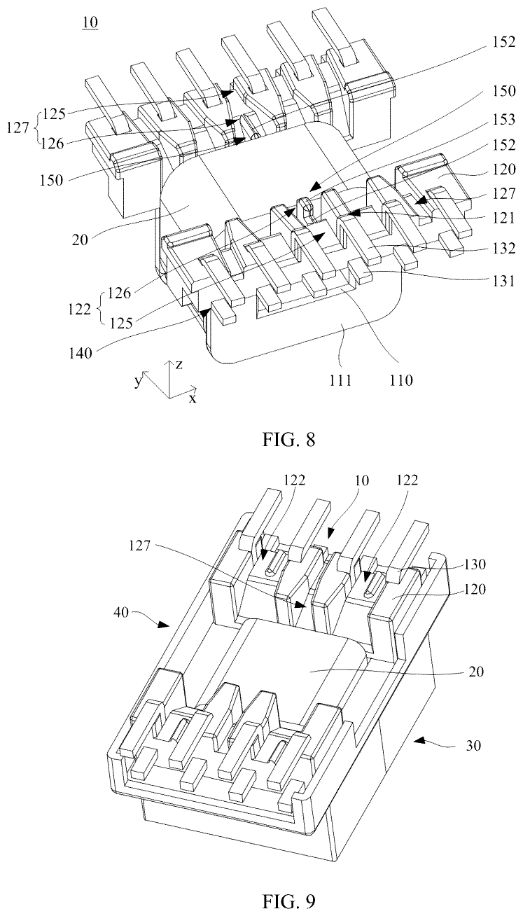

Exemplarily, referring to FIG. 1, FIG. 2, FIG. 3, FIG. 7 and FIG. 8, a side of the pin connection part 120 facing away from the first wire-passing groove 122 can be provided with a containing cavity 140. The containing cavity 140 is connected to the connecting through-hole 121. The containing cavity 140 is used to contain part of the first bending portion of the pin 130. The containing cavity 140 contacts part of the first bending part, thereby increasing contact area between the pin connection part 120 and the pin 130, and improving the connection strength between the pin connection part 120 and the pin 130.

The pin connection part 120 may also be provided with at least one first wire-passing groove 122. The first wire-passing groove 122 is located between two adjacent connecting through-holes 121. The first wire-passing groove 122 passes through the pin connection part 120 along the direction of the center line of the winding reel 110. A partial area of the groove wall of the first wire-passing groove 122 is located in at least one connecting through-hole 121 adjacent the first wire-passing groove 122 to expose the pin 130. The lead wire 210 of the winding 20 is passed through the first wire-passing groove 122.

Exemplarily, a partial area of the groove wall of the first wire-passing groove 122 may be located in a connecting through-hole 121 adjacent the first wire-passing groove 122, that is, the portion of the pin connection part 120 located between the wire-passing groove and a connecting through-hole adjacent to the wire-passing groove is removed. Exemplarily, referring to FIG. 1 to FIG. 5, a partial area of the groove wall of the first wire-passing groove 122 may also be located in two connecting through-holes 121 adjacent the first wire-passing groove 122, that is, the portion of the pin connection part 120 located between the wire-passing groove and the two connecting through-holes adjacent to wire-passing groove is removed to further increase a groove width of the first wire-passing groove 122.

The number of first wire-passing grooves 122 may be one, two or more, and the embodiment of the present application may not specifically limit the number of first wire-passing grooves 122.

The first wire-passing groove 122 may be provided on a side of at least one pin 130. Exemplarily, one first wire-passing groove 122 may be provided on a side of one pin 130, that is, a portion of the pin connection part located between one pin and one wire-passing groove adjacent the pin 130 in the related art may be cut off. Exemplarily, a first wire-passing groove 122 may also be provided on a side of part of pins 130, that is, a portion of the pin connection part located between part of pins and one wire-passing groove adjacent the part of pins 130 in the related art may also be cut off. Exemplarily, a first wire-passing groove 122 may also be provided on a side of all pins 130, that is, a portion of the pin connection part located between all pins and one wire-passing groove adjacent all the pins 130 in the related art may also be cut off.

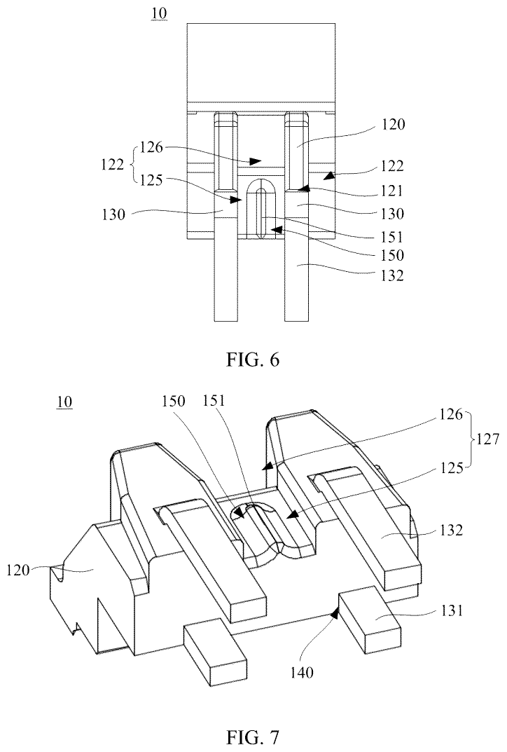

In some embodiments of the present application, the first wire-passing groove 122 may be provided on two sides of at least one pin 130. Exemplarily, the first wire-passing groove 122 may be provided on two sides of one pin 130, that is, a portion of the pin connection part located between one pin 130 and two wire-passing grooves adjacent the pin 130 in the related art may be cut off. Exemplarily, referring to FIG. 8, the first wire-passing groove 122 may be provided on two sides of part of pins 130, that is, the portion of the pin connection part located between part of pins 130 and two wire-passing grooves adjacent the part of pins 130 in the related art may be cut off. Exemplarily, referring to FIG. 6, the first wire-passing groove 122 may be provided on two sides of all pins 130, that is, the portion of the pin connection part located between all pins 130 and two wire-passing grooves adjacent all the pins 130 in the related art may be cut off.

Referring to FIG. 1 to FIG. 5, the pin connection part 120 may also be provided with a second wire-passing groove 127. The second wire-passing groove 127 is located between two adjacent connecting through-holes 121 which are not provided with the first wire-passing groove 122. The second wire-passing groove 127 passes through the pin connection part 120 along the direction of the center line of the winding reel 110, for example, the direction y shown in FIG. 1.

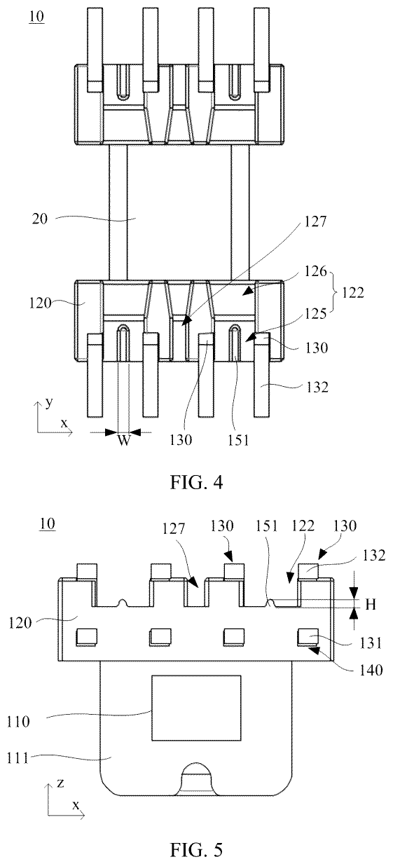

Referring to FIG. 1, FIG. 2, FIG. 4, FIG. 5, FIG. 6, FIG. 7 and FIG. 8, the first wire-passing groove 122 or the second wire-passing groove 127 can be used for threading the two lead wires 210 of the winding 20. The first wire-passing groove 122 or the second wire-passing groove 127 is provided with a partition part 150, and the partition part 150 separates the two lead wires 210 to prevent the two lead wires 210 from contacting and causing a short circuit, thereby improving the reliability of the transformer. Exemplarily, referring to FIG. 1 to FIG. 6, a partition part 150 can be provided in the first wire-passing groove 122. Referring to FIG. 7, the second wire-passing groove 127 can also be provided with the partition part 150. Referring to FIG. 8, both the first wire-passing groove 122 and the second wire-passing groove 127 can be provided with the partition part 150.

Referring to FIG. 1, FIG. 2, FIG. 4, FIG. 6, FIG. 7 and FIG. 8, the first wire-passing groove 122 or the second wire-passing groove 127 may include a first sub-groove 125 and a second sub-groove 126 connected to each other, and the first sub-groove 125 is located between two pins 130 adjacent the first sub-groove 125. The second sub-groove 126 is located on a side of the first sub-groove 125 facing the winding reel 110. The lead wire 210 of the winding 20 is connected to the pin 130 after passing through the second sub-groove 126 and the first sub-groove 125 in sequence.

The partition part 150 may include a first partition part 151 and/or a second partition part 152, the first partition part 151 may be located in the first sub-groove 125, and the second partition part 152 may be located in the second sub-groove 126. Exemplarily, referring to FIG. 1 to FIG. 7, the partition part 150 may include a first partition part 151, and the first partition part 151 may be located in the first sub-groove 125. The lead wire 210 in the first sub-groove 125 can be separated by the first partition part 151 to prevent the lead wires 210 from contacting each other and causing a short circuit.

Exemplarily, referring to FIG. 4, along a direction of a line connecting two pins 130 adjacent to the first partition part 151, for example, the direction x shown in FIG. 4, a width of the first partition part 151 can be greater than or equal to 0.05 mm and less than or equal to 3 mm. For example, the width of the first partition part 151 can be 0.05 mm, 1 mm, 1.5 mm, 2 mm, 2.5 mm, or 3 mm. The first partition part 151 located within the width range can separate the lead wire 210 and has a sufficiently small width to avoid excessively increasing the distance between the two pins 130, thereby ensuring a smaller volume of the bobbin 10 and further ensuring the miniaturization of the transformer.

Referring to FIG. 5, along the direction perpendicular to the center line of the winding reel 110, for example, the direction z shown in FIG. 5, a height of the first partition part 151 can be greater than or equal to 0.05 mm and less than or equal to 5 mm. For example, the height of the first partition part 151 can be 0.05 mm, 1 mm, 2 mm, 3 mm, 4 mm, or 5 mm. The first partition part 151 located within the height range can separate the lead wire 210 and has a sufficiently small height to avoid excessively increasing the distance between the two pins 130, thereby ensuring the smaller volume of the bobbin 10 and further ensuring the miniaturization of the transformer.

Exemplarily, referring to FIG. 8, the partition part 150 may also include a second partition part 152, and the second partition part 152 may be located in the second sub-groove 126. Since the second sub-groove 126 is located on the side of the first sub-groove 125 facing the winding reel 110, that is, the second sub-groove 126 is not provided between the two pins 130. The second partition part 152 is arranged in the second sub-groove 126, so that the lead wire 210 can be separated and the distance between the two pins 130 can be avoided from being increased, thereby avoiding increasing the volume of the bobbin 10, which is conducive to the miniaturization of the transformer.

Referring to FIG. 1, FIG. 2, FIG. 4, FIG. 5, FIG. 7 and FIG. 8, along a direction from the pin connection part 120 to the winding reel 110, for example, the direction y shown in FIG. 1, the groove bottom of the second sub-groove 126 is inclined toward the center line of the winding reel 110. This arrangement enables the lead wire 210 to smoothly extend from the winding 20 to the first sub-groove 125, thereby improving the convenience of routing the lead wire 210.

Exemplarily, referring to FIG. 8, the second partition part 152 located in the second sub-groove 126 may be a triangular plate, and a side of the triangular plate is connected to the groove bottom of the second sub-groove 126. The triangular plate can be contained in the second sub-groove 126. The triangular plate has sufficiently large enough area, and does not extend out from the second sub-groove 126, thus fully ensuring function of the second partition part 152 to separate the lead wires 210 without increasing the volume of the bobbin 10, which is beneficial to the reliability and miniaturization of the transformer.

Exemplarily, a side of the triangular plate facing away from a groove bottom of the second sub-groove 126, and facing a groove notch of the second sub-groove 126 is provided with a protruding part 153, a side of the protruding part 153 facing away from the triangular plate is flush with a surface of the pin connection part 120. This arrangement further increases area of the second partition part 152 and makes the second partition part 152 not extend out from the second sub-groove 126, which is further beneficial to the reliability and miniaturization of the transformer.

Referring to FIG. 8, along the direction from the pin connection part 120 to the winding reel 110 and the direction y shown in FIG. 8, groove walls of two sides the second sub-groove 126 are inclined arranged in a direction away from each other, so as to increase the groove space in the second sub-groove 126 without increasing the distance between the two pins 130, thereby increasing the wire-passing space of the lead wire 210.

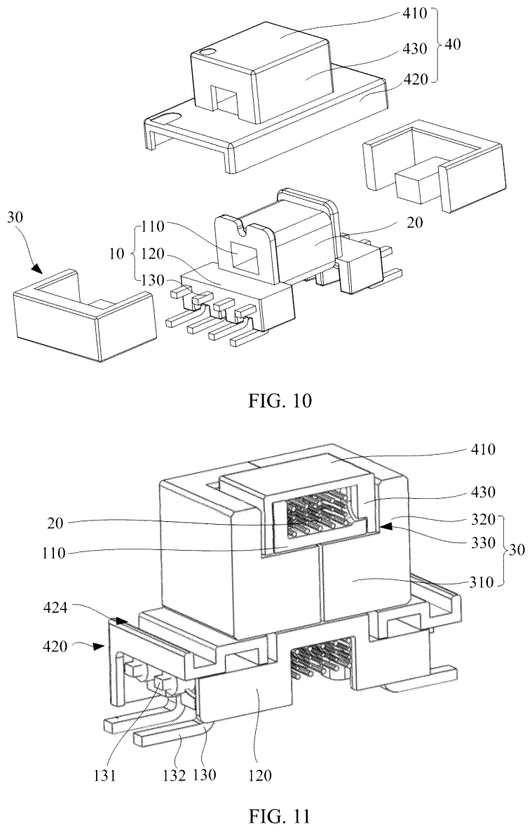

An embodiment of the present application also provides a transformer. Referring to FIG. 9 and FIG. 10, the transformer includes a magnetic core assembly 30, a winding 20, a protection member 40, and a bobbin 10 as described in any one of the above items. The magnetic core assembly 30 includes two opposing magnetic cores. At least part of the winding reel 110 of the bobbin 10 is provided within the magnetic core assembly 30. The winding 20 is provided on the winding reel 110. The winding 20 is electrically connected to a pin 130 of a pin connection part 120 in the bobbin 10. For example, the winding 20 has a lead wire 210, and the lead wire 210 is electrically connected to the pin 130. The protection member 40 includes a suction member part 410 and an isolating part 420. The suction member part 410 is at least partially provided above the bobbin 10. The isolating part 420 is connected to the suction member part 410, and the isolating part 420 covers at least part of the winding reel 110 and at least part of the pin connection part 120. The isolating part 420 is used to isolate the pin 130 of the pin connection part 120.

The transformer of the embodiment of the present application is provided in the magnetic core assembly 30 through the bobbin 10 and part of the protection member 40. The bobbin 10 is used to wind the winding 20 and plays a role in supporting the winding 20. The suction member part 410 of the protection member 40 is at least partially provided above the bobbin 10, so that the suction member part 410 plays a role in protecting a top of the bobbin 10, at the same time, the suction member part 410 can also be used for adsorption of other adsorption equipment to complete the lifting, shifting and other processes. The current output is realized by electrically connecting the pin 130 to the winding 20. By at least partially setting the pin connection part 120 into the isolating part 420 of the protection member 40, the isolating part 420 is used to isolate the pin connection part 120, and the isolating part 420 serves as an isolation area between a magnetic core and the pin connection part 120, safety distance and withstand voltage requirements between the pin connection part 120 and the magnetic core assembly 30 can be met within a minimum size range, which has advantages of high withstand voltage requirements and large safety distance.

In one embodiment, as shown in FIG. 9 and FIG. 10, a top end surface of the magnetic core assembly 30 along its height direction is a flush structure. The suction member in the related art is usually a cover plate, and the cover plate is usually fixed to the magnetic core assembly 30 by a clamping structure. Specifically, a clamping block is provided on the cover plate, and a notch is provided on a top surface of the magnetic core assembly 30 corresponding to the clamping block, and the clamping block is clamped in the notch to form a clamping structure. Since the whole winding 20 is wrapped around the magnetic core, the notch can only be opened in the area with minimal electrical impact, which is difficult to process. At the same time, the setting of the notch may cause the problem of stress concentration in the magnetic core assembly 30, which reduces structural strength and easily causes a risk of cracking. The top end surface of the magnetic core assembly 30 provided in this embodiment along its height direction is a flush structure, that is, no notch is provided on the top end surface of the magnetic core assembly 30 along its height direction, so as to avoid stress concentration and improve reliability of the magnetic core assembly 30.

It is understandable that, as shown in FIG. 9 and FIG. 10, the suction member part 410 provided in the embodiment of the present application is connected to the isolating part 420 through the connecting part 430 to achieve a fixation of the suction member part 410 and ensure a fixing effect between the suction member part 410 and the magnetic core assembly 30. The suction member part 410 is embedded in the magnetic core assembly 30 to ensure that the suction member part 410 will not fall off. At the same time, the suction member part 410 does not need to be clamped with the magnetic core assembly 30, so there is no need to open a notch on the magnetic core assembly 30, which reduces difficulty of processing and reduces production cost.

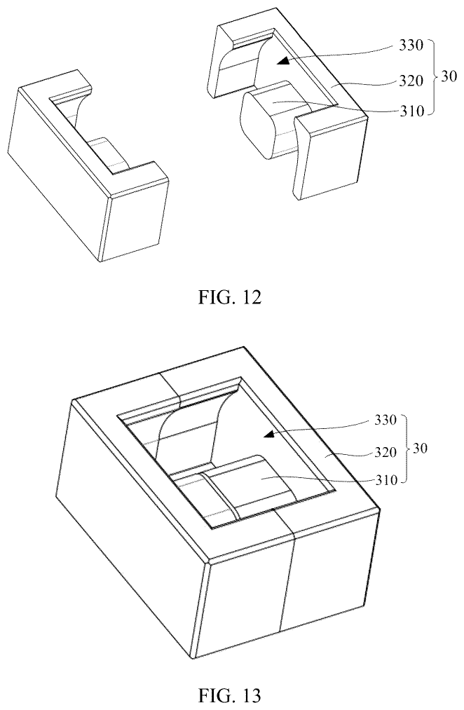

Specifically, as shown in FIG. 11, FIG. 12 and FIG. 13, in the embodiment of the present application, the magnetic core shape of the magnetic core assembly 30 is an EE structure. Each magnetic core includes a body 320 and a central column 310. The body 320 is similar to a U-shaped structure, so that the two oppositely arranged magnetic cores are folded together to form a structure similar to a rectangular. The central column 310 is provided on an inner side of the body 320, and the central columns 310 of the two magnetic cores are arranged facing each other. A size of the central column 310 is smaller than a size of the body 320, so that an accommodation cavity 330 is formed between the body 320 and the central column 310. The accommodation cavity 330 is used to accommodate at least part of the bobbin 10 and part of the protection member 40. Along a direction of a center line of the winding reel 110, the two oppositely arranged magnetic cores are respectively passed through in the winding reel 110 of the bobbin 10. Where, the suction member part 410 can be at least partially provided in an upper part of the accommodation cavity 330, which is equivalent to the suction member part 410 being at least partially embedded in interior of the magnetic core assembly 30 to ensure the fixing effect of the magnetic core assembly 30 on the suction member part 410. Certainly, the magnetic core shape of the magnetic core assembly 30 can also be an EI structure or any other magnetic core shape according to actual requirements. It can be understood that structure of the protection member 40 will also adapt to corresponding structure change of the magnetic core assembly 30.

It can be understood that a top surface of the suction member part 410 can be flush with the top end surface of the magnetic core assembly 30, or the top surface of the suction member part 410 protrudes relative to the top end surface of the magnetic core assembly 30. A relative position between the top surface of the suction member part 410 and the top end surface of the magnetic core assembly 30 is not limited by the embodiment of the present application, and can be adjusted according to actual production requirements, which is within the protection scope of the embodiment of the present application as long as other adsorption device can achieve adsorption of the suction member part 410.

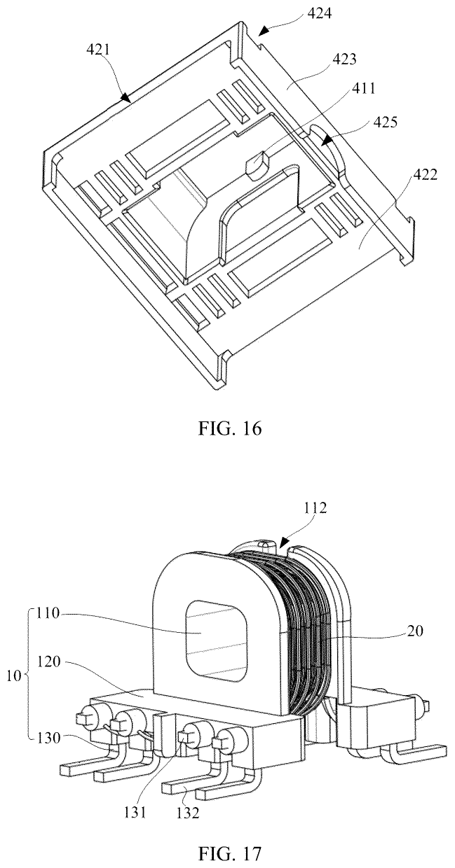

In some embodiments of the present application, as shown in FIG. 15, the protection member 40 may also include a connecting part 430. The connecting part 430 is provided within the magnetic core assembly 30. The connecting part 430 is located between the suction member part 410 and the isolating part 420. Two ends of the connecting part 430 are connected to the suction member part 410 and the isolating part 420.

By the connecting part 430 being located between the suction member part 410 and the isolating part 420, the connecting part 430 serves as function of intermediate connection between the suction member part 410 and the isolating part 420, so that the suction member part 410, the connecting part 430, and the isolating part 420 are connected into an integrated structure.

It can be understood that in the related art, wires of the winding is on an outer side and close to the magnetic core, and any damage or aging of the wires is prone to poor withstand voltage. However, in the embodiment of the present application, the connecting part 430 can be wrapped around an outside of the entire winding 20. The connecting part 430 serves as a protection area of the winding 20 to prevent the magnetic core assembly 30 from scratching the winding 20 during assembly. Moreover, since the connecting part 430 is equivalent to covering the outside of the winding 20, it can also prevent adhesive glue between the protection member 40 and the magnetic core assembly 30 from adhering to the winding 20, further playing a role in protecting the winding 20.

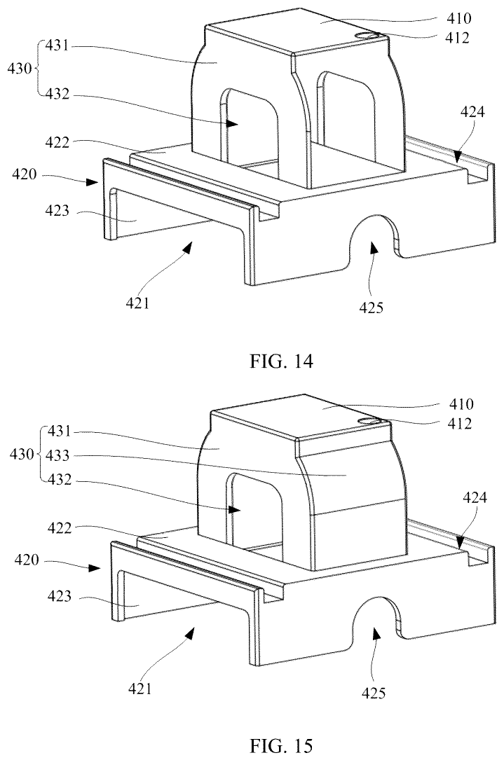

In some embodiments of the present application, as shown in FIG. 14, the connecting part 430 includes two first side plates 431 arranged opposite to each other. The two first side plates 431 is connected to the suction member part 410, and the two first side plates 431 is provided between the bobbin 10 and the magnetic core assembly 30.

The two first side plates 431 is provided vertically relative to the isolating part 420, a bottom of the two first side plates 431 is connected to the isolating part 420, and a top of the two first side plates 431 is connected to the suction member part 410, so as to provide a good support effect for the suction member part 410. By setting the two first side plates 431 between the bobbin 10 and the magnetic core assembly 30, the two first side plates 431 plays the role of isolating the winding 20 from the magnetic core assembly 30, thus ensuring the safety distance and withstand voltage requirements of the winding 20 to a certain extent.

In some embodiments of the present application, the two first side plates 431 may be provided with a through hole 432, and the magnetic core assembly 30 is partially passed through the through hole 432. By providing the through hole 432 in the two first side plates 431, the through hole 432 provides an avoidance space for the magnetic core assembly 30, so that the central column 310 of the magnetic core assembly 30 can pass through the through hole 432 and extend into the bobbin 10, so as to perform electromagnetic effect between the winding 20 and the magnetic core assembly 30.

In some embodiments of the present application, as shown in FIG. 15, the connecting part 430 further includes two second side plates 433 arranged opposite to each other. The second side plate 433 is connected to the suction member part 410 and provided between the two first side plates 431. The second side plate 433 is provided between the winding 20 and the magnetic core assembly 30.

If the connecting part 430 has only two first side plates 431 arranged opposite to each other, the two first side plates 431 form a structure with two opening ends. By the connecting part 430 also including two second side surfaces arranged opposite to each other, the second side plate 433 is connected to the suction member part 410 and arranged between the two first side plates 431, the second side surface realizes intermediate connection effect between the suction member part 410 and the isolating part 420. At this time, four side edges of the suction member part 410 are supported by the two first side plates 431 and the two second side surfaces, further ensuring the support effect of the suction member part 410. At the same time, the two second side surfaces are equivalent to blocking the two opening ends of a structure with an opening 421 at two ends, so that the connecting part 430 can completely wrap and isolate the outside of the winding 20, avoid a situation where the winding 20 is partially exposed, further ensure the safety distance and withstand voltage requirements of the winding 20, and make the connecting part 430 have the advantages of high withstand voltage requirements and large safety distance.

In some embodiments of the present application, the suction member part 410, the isolating part 420 and the connecting part 430 may be an integrally formed structure.

Compared with a split structure, by setting the suction member part 410, the isolating part 420 and the connecting part 430 as an integrally formed structure, the integrated structure is adopted, the parts assembly process is reduced, and the production cost is relatively low. At the same time, the suction member part 410, the isolating part 420 and the connecting part 430 form a relatively closed structure, which can still meet the requirements of withstand voltage and safety distance even if an abnormality occurs, and will not cause safety problems due to failure, and has high reliability.

It can be understood that in some embodiments of the present application, the protection member 40 is made of insulating material to ensure the insulation and isolation effect of the winding 20 and the pin 130.

In some embodiments of the present application, as shown in FIG. 14 and FIG. 15, along an axial direction of the winding 20, openings 421 are provided on two sides of the isolating part, and the pins 130 at least partially pass through a bottom of the openings 421.

By providing the openings 421 on two sides of the isolating part 420, the openings 421 provide an avoidance space for the pins 130, so that at least part of the pins 130 can extend out from the openings 421 and pass through a bottom of the isolating part 420, so that the pins 130 can be connected with other electrical devices.

In some embodiments of the present application, the isolating part 420 includes a connecting plate 422 and two baffles 423, and the connecting plate 422 is connected to the connecting part 430. The two baffles 423 are provided on two sides of the connecting plate 422 along a radial direction of the winding 20. The pin connection part 120 is partially accommodated between the connecting plate 422 and the two baffles 423.

By providing the connecting plate 422 of the isolating part 420 being connected to the connecting part 430, the connecting plate 422 plays the role of connecting with the connecting part 430. By providing two baffles 423 on two sides of the connecting plate 422 along the radial direction of the winding 20, the connecting plate 422 and the two baffles 423 form a U-shaped structure. An accommodating space is formed between the connecting plate 422 and the two baffles 423. The accommodating space is used to partially accommodate the pin 130. Under a joint action of the connecting plate 422 and the two baffles 423, the pin 130 is partially isolated to meet the safety distance and withstand voltage requirements of the pin 130. At the same time, the baffle 423 plays the role of a supporting leg of the entire transformer to ensure supporting effect of the transformer. In addition, a lead end of the winding 20 is connected to the pin 130, that is, the pin 130 is provided at two ends of the winding 20 along the axial direction. For this purpose, by providing two baffles 423 on two sides of the connecting plate 422 along the radial direction of the winding 20, the baffles 423 realizes avoidance of the connecting wire harness between the pin 130 and the winding 20.

In some embodiments of the present application, as shown in FIG. 14 and FIG. 15, an isolation groove 424 is provided on the surface of the protection member 40. Specifically, an isolation groove 424 is provided on the connecting plate 422.

Creepage distance is the shortest path measured along the insulating surface between two conductive components, or between a conductive component and an equipment protection interface. By providing the isolation groove 424 on the surface of the protection member 40, it is equivalent to increasing the creepage distance, and further ensuring the insulation effect.

It can be understood that a cross section of the isolation groove 424 can be rectangular, triangular, arc-shaped structure, etc. This embodiment does not limit cross-sectional shapes of the isolation groove 424, which is within the protection scope of this embodiment, as long as the effect of increasing the creepage distance can be achieved.

It can be understood that two isolation grooves 424 are provided on the connecting plate 422. The isolation grooves 424 are respectively provided on two sides of the connecting part 430, which ensures symmetrical balance effect while ensuring the isolation effect between the pin 130 and the winding 20. This embodiment does not limit number of the isolation grooves 424, and can be adjusted according to actual production requirements.

In some embodiments of the present application, as shown in FIG. 14 and FIG. 15, a first identification part 425 is provided on a side of the protection member 40 along the radial direction of the winding 20. Specifically, a first identification part 425 is provided on one of the baffles 423, and the first identification part 425 plays the role of an identifier.

Since the entire protection member 40 is a symmetrical structure relative to the winding 20, if the protection member 40 is not provided with any identification, the two sides of the protection member 40 along the radial direction of the winding 20 cannot be identified, and it is difficult to confirm whether it is the left side or right side of the protection member 40. By providing a first identification part 425 on a side of the protection member 40 along the radial direction of the winding 20, the left and right sides of the protection member 40 can be quickly and timely distinguished by using the first identification part 425 to identify single side of the protection member 40, which provides great convenience for assembly and subsequent maintenance.

In some embodiments of the present application, as shown in FIG. 14 and FIG. 15, a second identification part 412 is provided on the top surface of the suction member part 410.

Since the entire protection member 40 is a symmetrical structure relative to the winding 20, if the protection member 40 is not provided with any identification, the two sides of the protection member 40 cannot be identified, and it is difficult to confirm which specific side the protection member 40 is. By providing a second identification part 412 on the top surface of the suction member part 410, the second identification part 412 plays a role of identification. Which specific side the protection member 40 is can be quickly and promptly distinguished by using the second identification part 412 to identify a single side of the protection member 40, avoiding a situation of single-side confusion, and providing great convenience for assembly and subsequent maintenance. In addition, the suction member part 410 is located at a top position of the whole transformer. The second identification part 412 is provided at the top of the suction member part 410, which is convenient for viewing the second identification part 412.

It can be understood that the second identification part 412 may be provided on a side of the suction member part 410 along the direction perpendicular to the center line of the winding 20, or the second identification part 412 may be provided on a side of the suction member part 410 along the direction of the center line of the winding 20, or the second identification part 412 is provided at a corner of the suction member part 410. This embodiment does not limit the specific position of the second identification part 412 in the suction member part 410, it can identify whether the winding 20 is in the axial or radial direction according to actual production.

It can be understood that the first identification part 425 and the second identification part 412 can be provided independently of each other, and both the first identification part 425 and the second identification part 412 are independent of each other and do not interfere with each other; the first identification part 425 and the second identification part 412 can also work in coordination, for example, one of the identification parts is used to identify a side along the axial direction of the winding 20, and the other is used to identify a side along the radial direction of the winding 20.

It can be understood that the first identification part 425 and the second identification part 412 can also be called a fool-proof design, which can be completed by making a mold for the protection member 40, avoiding a situation where the PIN identification point is missing or printed in reverse.

In some embodiments of the present application, as shown in FIG. 16 and FIG. 17, the bobbin 10 includes a winding reel 110, the winding 20 is wound around the winding reel 110, and the magnetic core assembly 30 is partially passed through the winding reel 110.

The winding reel 110 provides a winding position for the winding 20 by wounding winding 20 on the winding reel 110. A through-hole is provided in the winding reel 110 along its center line direction, so that two central columns 310 opposite to the magnetic core in the magnetic core assembly 30 can pass through the through-hole respectively, which is convenient for the magnetic core and the winding 20 to perform electromagnetic effect.

For the side where the winding reel 110 and the protection member 40 are close to each other, one is provided with a positioning projection 411, and the other is provided with a positioning groove 112. The positioning projection 411 is at least partially provided in the positioning groove 112. In some embodiments, the positioning projection 411 disposed on one side of the winding reel 110, and the positioning groove 112 disposed on one side of the protection member 40. In other embodiments, the positioning projection 411 disposed on one side of the protection member 40, and the positioning groove 112 disposed on one side of the winding reel 110.

If the protection member 40 is directly covered on the outside of the bobbin 10, it is difficult to ensure a relative position between the protection member 40 and the bobbin 10. By for the side where the winding reel 110 and the protection member 40 are close to each other, one being provided with a positioning projection 411, and the other being provided with a positioning groove 112, the positioning projection 411 is at least partially provided in the positioning groove 112. Under the mutual cooperation of the positioning projection 411 and the positioning groove 112, a positioning between the winding reel 110 and the protection member 40 is achieved, so as to ensure accuracy of the relative position between the protection member 40 and the bobbin 10 and avoid occurrence of a situation of a large positional deviation between the protection member 40 and the bobbin 10.

In some embodiments of the present application, as shown in FIG. 17, the bobbin 10 also includes a pin connection part 120 and is connected to the winding reel 110. The number of the pin connection parts 120 can be two. The winding reel 110 is located between the two pin connection parts 120. The pin 130 is inserted within the connecting through-hole 121 of the pin connection part 120. Where the isolating part 420 is covered on the outside of the pin connection part 120.

By connecting the winding reel 110 and the pin 130 to the pin connection part 120, the pin connection part 120 plays the role of supporting the winding reel 110 and the pin 130. The pin connection part 120 also provides an installation position for the pin 130 to ensure the support effect of the winding reel 110 and the pin 130. By setting the isolating part 420 to cover the outside of the pin connection part 120, the part of the pin 130 located inside the pin connection part 120 can be isolated and protected.

It should be noted that the pin connection part 120 can be made of insulating material. The pin 130 is usually made of metal material (such as phosphor bronze with a smooth surface and high gloss), or matte tin plated on a nickel-plated surface.

In some embodiments of the present application, the winding 20 may include multiple coils, and the multiple coils are wound around the magnetic core assembly 30.

The transformer provided in this embodiment is mainly used for driving control IC or driving computer and other equipment, and is extensive used in many systems such as an on-board charger (OBC), a battery management system (BMS), a power control system (PCU), an electrical control system (ECU), and a DC-DC conversion unit (DCDC) of vehicles.

The transformer provided in this embodiment is suitable for various low-power transformer process used in new energy vehicles. In terms of electrical performance, high withstand voltage and safety distance are required; in terms of mechanical performance, high vibration resistance is required. The transformer provided in this embodiment is a low-power transformer process structure platform, which has high withstand voltage and safety distance, high vibration resistance, high reliability and full automation. Product series corresponding to the process requirements of various low-power transformers for vehicles can be expanded based on this platform.

Finally, it should be noted that the above embodiments are only used to illustrate the technical solutions of the present application, rather than to limit it. Although the present application has been described in detail with reference to the foregoing embodiments, it should be understood by those skilled in the art that the technical scheme described in the foregoing embodiments can still be modified, or some or all of its technical features can be replaced by equivalents. However, these modifications or substitutions do not make the essence of the corresponding technical solutions deviate from the scope of the technical solutions of various embodiments of the present application.

What is claimed is:

1. A bobbin, comprising:
a winding reel configured to wind a winding; and
at least one pin connection part disposed on an end surface of the winding reel, the pin connection part comprises a plurality of connecting through-holes and at least one first wire-passing groove, the plurality of connecting through-holes are arranged at intervals along a direction parallel to the end surface of the winding reel and each connecting through-hole is inserted with a pin;
wherein the first wire-passing groove is located between two adjacent connecting through-holes, the first wire-passing groove passes through the pin connection part along a direction of a center line of the winding reel, and a partial area of a groove wall of the first wire-passing groove is located in at least one connecting through-hole adjacent the first wire-passing groove to expose the pin.

2. The bobbin according to claim 1, wherein the first wire-passing groove is disposed on one side of at least one of the pins; and/or
the first wire-passing groove is disposed on two sides of at least one of the pins.

3. The bobbin according to claim 1, wherein the pin connection part further comprises a second wire-passing groove, the second wire-passing groove is located between two adjacent connecting through-holes that are not disposed on the first wire-passing groove, and the second wire-passing groove passes through the pin connection part along the direction of the center line of the winding reel.

4. The bobbin according to claim 3, wherein the first wire-passing groove or the second wire-passing groove is configured to thread two lead wires of the winding;
a partition part is disposed in the first wire-passing groove or the second wire-passing groove, and the partition part separates the two lead wires.

5. The bobbin according to claim 4, wherein the first wire-passing groove or the second wire-passing groove comprises a first sub-groove and a second sub-groove connected to each other, the first sub-groove is located between the two pins adjacent the first sub-groove; and the second sub-groove is located on a side of the first sub-groove facing the winding reel.

6. The bobbin according to claim 5, wherein the partition part comprises a first partition part and/or a second partition part, the first partition part is located in the first sub-groove, and the second partition part is located in the second sub-groove.

7. The bobbin according to claim 6, wherein along a direction of a line connecting two pins adjacent to the first partition part, a width of the first partition part is greater than or equal to 0.05 mm and less than or equal to 3 mm; or
along a direction perpendicular to the center line of the winding reel, a height of the first partition part is greater than or equal to 0.05 mm and less than or equal to 5 mm.

8. The bobbin according to claim 6, wherein along a direction pointing from the pin connection part to the winding reel, a groove bottom of the second sub-groove is configured to be inclined toward the center line of the winding reel.

9. The bobbin according to claim 8, wherein the second partition part is a triangular plate, and a side of the triangular plate is connected to the groove bottom of the second sub-groove.

10. The bobbin according to claim 9, wherein a side of the triangular plate facing away from the groove bottom of the second sub-groove and toward a groove notch of the second sub-groove is provided with a protruding part, a side of the protruding part facing away from the triangular plate is flush with a surface of the pin connection part.

11. The bobbin according to claim 6, wherein along a direction pointing from the pin connection part to the winding reel, groove walls of two sides of the second sub-groove are arranged to be inclined toward a direction away from each other.

12. The bobbin according to claim 1, wherein an end of the pin close to the winding reel extends out of the connecting through-hole, and bends in the direction away from the winding reel to form a first bending part, the first bending part is configured to connect a lead wire of the winding;
an end of the pin away from the winding reel extends out of the connecting through-hole, and bends away from the winding reel to form a second bending part, the second bending part is configured to be connected with a circuit board.

13. The bobbin according to claim 12, wherein a side of the pin connection part facing away from the first wire-passing groove comprises a containing cavity, the containing cavity is connected to the connecting through-hole, and the containing cavity is configured to contain a part of the first bending part of the pin.

14. A transformer, comprising a magnetic core assembly, a winding, a protection member, and a bobbin according to claim 1;
the magnetic core assembly comprises two opposing magnetic cores; at least part of the winding reel of the bobbin is disposed in the magnetic core assembly;
the winding is disposed on the winding reel, and electrically connected to a pin of the pin connection part in the bobbin;
the protection member comprises a suction member part and an isolating part, the suction member part is at least partially disposed above the bobbin; the isolating part is connected to the suction member part, the isolating part covers at least part of the winding reel and at least part of the pin connection part, and the isolating part is configured to isolate the pin of the pin connection part.

15. The transformer according to claim 14, wherein the protection member further comprises a connecting part, the connecting part is disposed in the magnetic core assembly, the connecting part is located between the suction member part and the isolating part, and two ends of the connecting part are connected to the suction member part and the isolating part.

16. The transformer according to claim 15, wherein the connecting part at least partially covers the bobbin.

17. The transformer according to claim 16, wherein the connecting part comprises two first side plates arranged opposite to each other, the two first side plates are connected to the suction member part, and the first side plate is disposed between the bobbin and the magnetic core assembly.

18. The transformer according to claim 17, wherein the two first side plates comprise a through hole, and the magnetic core assembly is partially passed through the through hole.

19. The transformer according to claim 14, wherein along the direction of the center line of the winding, openings are disposed on two sides of the isolating part, and the pins at least partially pass through under the openings.

20. The transformer according to claim 15, wherein the isolating part comprises a connecting plate and two baffles, the connecting plate is connected to the connecting part;
the two baffles are respectively disposed on two sides of the connecting plate along a direction perpendicular to the center line of the winding, and the connecting plate and the two baffles are configured to partially accommodate the pin connection part.
